(19) United States
(12) Patent Application Publication
(10) Pub. No.: US 2012/0001005 A1
(43) Pub. Date: Jan. 5, 2012

(54) GRINDER

(76) Inventors: Klaus KROESEN, Xanten (DE); Sebastian Beule, Bad Fredebrug (DE)

(21) Appl. No.: 13/170,219

(22) Filed: Jun. 28, 2011

(30) Foreign Application Priority Data
Jul. 5, 2010 (DE) 102010017721.0

(51) Int. Cl. A47J 42/12

(52) U.S. Cl. 241/257.1

(57) ABSTRACT

A grinder has a hollow housing, a support rotatable in the housing about an upright axis, a lower annular grinding disk fixed atop and rotatable with the support, and an upper grinding disk nonrotatably fixed in the housing above the lower disk and forming therewith a radially extending annular grinding gap. The disks form with the housing an annular outlet chamber into which the gap opens radially outwardly. The housing forms an upwardly open intake into which the gap opens radially inward. An electrical drive is connected to the support for rotating the support and lower disk in the housing so that material charged into the intake is ground in the gap and expelled as particles into the output chamber. An angular-contact bearing is braced axially and radially between the support and the housing below the disks.

### FIELD OF THE INVENTION

The present invention relates to a grinder. More particularly this invention concerns a coffee grinder.

### BACKGROUND OF THE INVENTION

A standard grinder, in particular for coffee beans, has a housing, a support rotatably mounted in the housing about an axis and on which a lower annular grinding disk is fixed, an upper annular grinding disk that is nonrotatably fixed in the housing, an upper housing opening for input of material to be ground, a radially or tangentially outwardly open output opening formed on the housing for ground material, and an electric drive for rotating the support.

Such grinders are known from the prior art. These grinders work with two annular grinding disks or rings. One of the grinding disks is stationary and the other grinding disk rotates and is coupled through the support to the electric drive. The material to be ground is loaded centrally and axially from above via an opening into the housing. A cone on the support protrudes into the opening and deflects the material to be ground radially outward into a gap between the disks. The material to be ground fed from the center is crushed by the grinding disks and conveyed outward by centrifugal force into a circumferentially extending grounds channel.

When crushing hard material, for example coffee beans, high impulsive loads occur between the grinding disks that must be absorbed by the grinding disks and their bearings. This high load must not result in axial separation of the disks because then, at least temporarily, the disk distance and thus the grind size changes. Also, to prevent blockage and overheating it is essential that the circumferential particle chamber is constantly emptied because otherwise the ground material overheats and the grinding degree can change because the ground material resides too long between the grinding disks.

It is standard to centrally guide and mount the rotating support with separate axial and radial bearings. As a result, the central arrangement of the bearings results forms a long lever arm between the bearing and the grinding region between the grinding disks so that due to the load occurring during grinding the beans, significant bending of the grinding disk support takes place. This in turn, in connection with unavoidable play in the bearings, results in fluctuations of the grinding disk distance and associated therewith in undesired fluctuations of the grinding degree of the ground material. Moreover, in particular the movable grinding disk is heavily mechanically stressed by the bending load that, in the worst case, can result in a breakage of the grinding disks.

In order to prevent this, standard grinders and grinding disks have previously been made of relatively expensive materials of high strength, typically metal, that are to be mechanically machined in a costly manner. To prevent blockages in the circumferentially extending particle chamber, it is made relative big so that the ground material stays in the particle chamber for a long time. The ground material, for example coffee powder, loses quickly its flavor and has an unpleasant taste.

### OBJECTS OF THE INVENTION

It is therefore an object of the present invention to provide an improved grinder.

Another object is the provision of such an improved grinder that overcomes the above-given disadvantages, in particular wherein the bending loads on the grinding disks are avoided to the largest possible extent and a consistent grinding degree of the ground material is achieved.

Moreover, according to the invention discharging the ground material from the particle chamber is to be carried out as continuously as possible and residues must not stay in the particle chamber.

### SUMMARY OF THE INVENTION

A grinder has according to the invention a hollow housing, a support rotatable in the housing about an upright axis, a lower annular grinding disk fixed atop and rotatable with the support, and an upper grinding disk nonrotatably fixed in the housing above the lower disk and forming therewith a radially extending annular grinding gap. The disks form with the housing an annular outlet chamber into which the gap opens radially outwardly. The housing forms an upwardly open intake into which the gap opens radially inward. An electrical drive is connected to the support for rotating the support and lower disk in the housing so that material charged into the intake is ground in the gap and expelled as particles into the output chamber. An angular-contact bearing is braced axially and radially between the support and the housing below the disks.

Due to the fact that the angular-contact bearings are directly below the annular grinding disks, and not centered but relatively far in the radial direction toward the outside, during operation of the grinder, the grinding disks are directly supported by the bearing so that an excellent mounting is achieved by means of which size fluctuations of the grinding gap between the disks are prevented. As a result, more uniform grind is achieved during grinding. Moreover, this configuration ensures that bending loads on the support and the grinding disks are avoided, resulting in a longer service life and fail-safe operation. Also, these measures allow the grinder, while achieving a better grinding degree consistency, to be made smaller, lighter and/or from better materials.

Preferably the angular-contact bearing is a ball bearing. Moreover, the bearing is annular. The angular bearing is configured and selected in such a manner that axial as well as radial forces can be absorbed without any problems.

To prevent that grinds from getting into the region of the bearing arrangement the housing is formed with an annular groove holding a sealing ring, preferably a felt ring, adjacent a lower face of the support and radially outward of the angular-contact bearing. This felt seal ring protects the bearing from ground particles.

To ensure good smoothness of operation of the grinder and to guarantee exact guidance of the support the support engages with a shaft projection through the bottom of the housing. This the shaft projection is mounted in a bearing sleeve fixed to the housing and, with interposition of a slide bearing, e.g. a spring ring, is axially supported with a collar on a collar of the bearing sleeve. This facilitates the smooth operation of the grinder.

For complete transport of the ground material, pusher elements engage with the gap and are fixed to the support or integrally formed with it. Rotation of the support makes the elements move the ground material in the chamber to an output opening of the housing. For transporting the ground material, a deflector is provided on the support to divert the ground material orbiting in the chamber to the output. This ensures that the chamber can be of small axial and radial dimensions with good transport of the ground material and a complete evacuation of the ground material. This deflector nose is preferably provided on the housing directly downstream of the output port, relative to the rotation direction of the support.

As a result, the ground material transported by the pushers is conveyed with high reliability to the output because the nose or deflector diverts the ground material carried along by the pushers to the output, thus into the output tube. Thus improved transport is achieved so that fresh ground material is delivered at any time and no blockages, overheating or overgrinding due to ground material remaining in the gap result.

### BRIEF DESCRIPTION OF THE DRAWING

The above and other objects, features, and advantages will become more readily apparent from the following description, reference being made to the accompanying drawing in which:

FIG. 1 is a small-scale perspective view of the grinder according to the invention;

FIG. 2 is a top view or elements of the grinder;

FIG. 3 is a partly sectional side view of the grinder;

FIG. 4 is a perspective view from above of the grinder; shows a grinder according to the invention including associated components in a top view;

FIG. 5 is a top view of the grinder;

FIG. 6 is a section taken along line VI--VI of FIG. 5; and

FIG. 7 is a section taken along line VII-VII of FIG. 5.

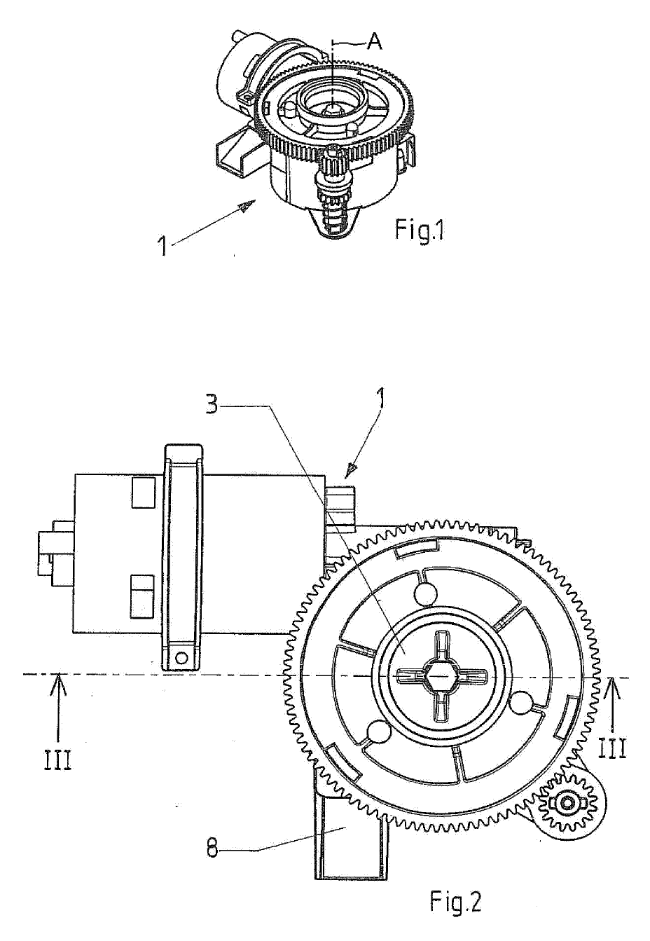

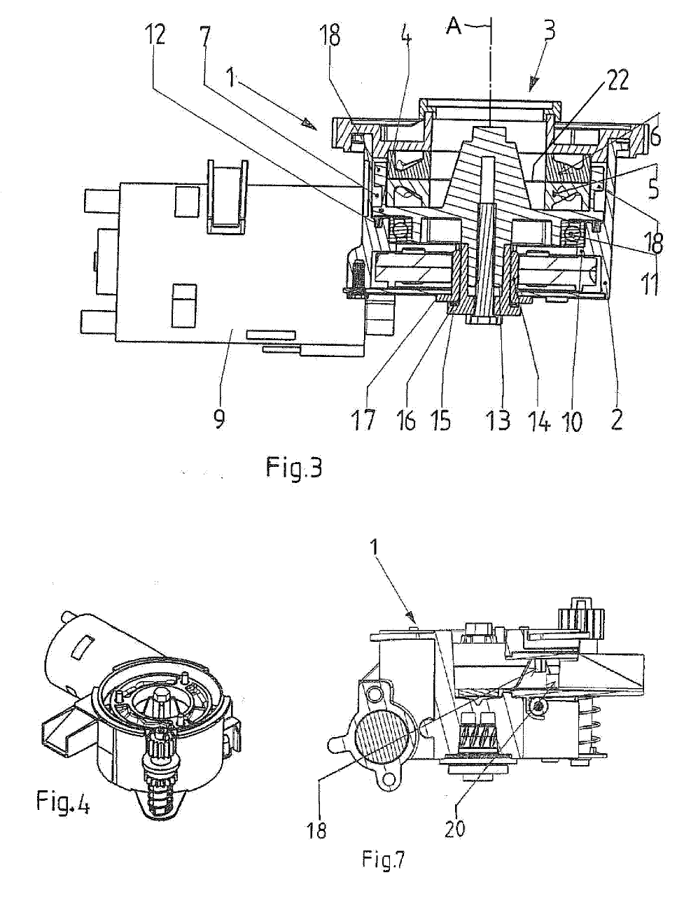

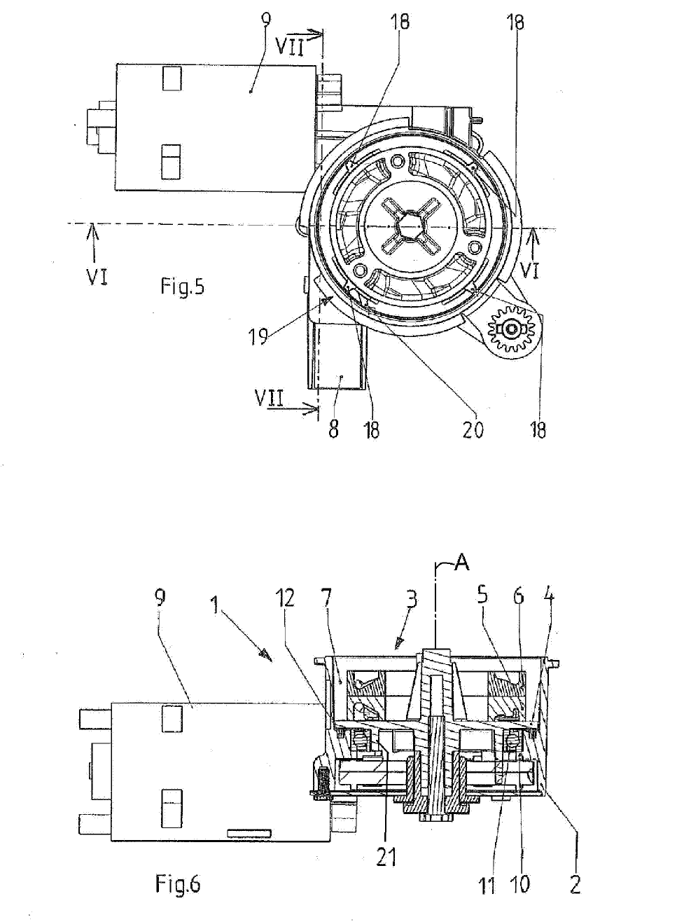

### DETAILED DESCRIPTION

A grinder 1 for material such as coffee beans has a housing 2 that in use has an upwardly open fill or input opening 3 for material to be ground. A one-piece support 4 is rotatable in the housing 2 about a vertical axis A and carries an annular grinding disk or ring 5 that is centered on the axis A and that has unillustrated upwardly directed small teeth. Above the lower grinding disk 5 fixed on the support 4, an upper annular grinding disk or ring 6 having unillustrated downwardly projecting small teeth is fixed on the housing 2 so that it cannot rotate or move axially. The two grinding disks 5 and 6 define a small grinding gap 22 that is radially inwardly and radially outwardly open and that lies in a plane perpendicular to the axis A.

The material to be ground thus is deflected into the radial inner periphery of the annular grinding gap 22 by a frustoconical upper part of the support 4, is comminuted between the disks 5 and 6, and the resultant particles are ejected radially outward from the gap 22 into an annular ground-material chamber 7 surrounding the disks 5 and 6 and defined radially between the disks and the housing 2. From there the ground material is ejected via an output port 19 of the chamber 7 into a tangentially extending output tube 8. The grinder is powered by an electric drive motor 9 coupled via worm gearing to the support 4 so as to rotate it. Viewed from above, the housing 2 is of cylindrical shape.

According to the invention, a single-row angular-contact ball bearing 11 is provided between the support 4 and the housing 2, oriented so as to resist axial downward movement of the support 4 relative to the housing 2 and radial movement of the support 4 relative to the housing. The angular-contact bearing 11 is directly below the support 4 and of course underneath the disks 5 and 6. Its outer bearing race is radially braced against the housing 2 and sits axially on a rim 10 of the housing 2 while the inner bearing race is positioned on a cylindrical ridge 21 projecting downward from the disk 7 and bears upward directly against a lower face of the support 4. This bearing 11 and the ridge 21 are spaced radially outward from a hub 13 of the support 4 and in fact has at the center of the orbit of its balls a radius equal to over half of the overall radius of the disk 4 so that it can therefore resist deflection of the support 4 and disk 5 easily. This arrangement ensures that during operation of the grinder 1, no significant bending forces act on the grinding disks 5 and 6 or the support 4 because the forces created by grinding are handily absorbed by the angular-contact bearing 11. The resulting advantages are described in the description above.

In addition, a compressible seal ring 12, preferably a felt ring, is provided in the housing 2 in a complementary annular groove and bears upward against a planar lower face of the disk 4 immediately adjacent its circular outer periphery and radially outside the angular-contact bearing 11. This prevents ground material or particles from penetrating into the region of the angular-contact bearing 11.

The support 4 extends with a shaft projection or hub 13 through the bottom of the housing 2 where the hub 13 is rotatable in a bearing sleeve 14 fixed to the housing 2. A slide bearing 16, e.g. a spring ring, is between a radially projecting collar 15 of a sleeve 14 fixed on the hub 13 and another such collar 17 of the sleeve 14.

Angularly equispaced pusher elements or vanes 18 carried on the disk 4 project radially outward in the chamber 7 and are formed on the support 4. They ensure angular movement of the particles in the chamber 7 and guarantee that they move through the port 19 into the output 8. The housing 2 is formed immediately downstream in the rotation direction of the support 4 and disk 5 with an inwardly projecting deflector bump 20 that diverts the particles orbiting in the chamber 7 into the port 19.

The invention is not limited to the illustrated embodiment but is highly variable within the context of the disclosure. All novel individual features and combined features disclosed in the description and/or the drawing are considered to be essential for the invention.

We claim:

1. A grinder comprising:
a hollow housing;
a support rotatable in the housing about an upright axis;
a lower annular grinding disk fixed atop and rotatable with the support;
an upper grinding disk nonrotatably fixed in the housing above the lower disk and forming therewith a radially extending annular grinding gap, the disks forming with the housing an annular outlet chamber into which the gap opens radially outwardly, the housing forming an upwardly open intake into which the gap opens radially inward;
an electrical drive connected to the support for rotating the support and lower disk in the housing, whereby material charged into the intake is ground in the gap and expelled as particles into the output chamber; and
an angular-contact bearing braced axially and radially between the support and the housing below the disks.

2. The grinder defined in claim 1, wherein the bearing is a ball bearing.

3. The grinder defined in claim 2, wherein the bearing is a single-row angular-contact ball bearing.

4. The grinder defined in claim 3, wherein the bearing has annular bearing races centered on the axis.

5. The grinder defined in claim 1, further comprising
a compressible ring engaged axially between confronting parallel faces of the support and the housing, radially outside the bearing, and centered on the axis.

6. The grinder defined in claim 5, wherein the housing face has an upwardly open annular groove in which the compressible ring is seated.

7. The grinder defined in claim 1, wherein the support has an axially centered and axially downwardly extending hub, the grinder further comprising:
respective sleeves fixed on the housing and hub and having axially radially outwardly projecting and juxtaposed and adjacent collars; and
a slide ring engaged axially between the collars.

8. The grinder defined in claim 7, wherein the slide ring is a spring ring.

9. The grinder defined in claim 1, wherein the lower disk is provided with a plurality of radially extending pusher vanes that orbit in the chamber on rotation of the lower disk so as to angularly move the particles in the chamber.

10. The grinder defined in claim 9, wherein the housing is formed with a radially or tangentially extending output tube and with an output port opening from the chamber into the tube.

11. The grinder defined in claim 10, further comprising a deflector provided partially blocking the chamber immediately downstream in a rotation direction of the support from the outlet port.

12. The grinder defined in claim 1 wherein the radial bearing is closer to an outer periphery of the lower disk than to the axis.
